(19) United States
(12) Patent Application Publication
(10) Pub. No.: US 2006/0100308 A1
(43) Pub. Date: May 11, 2006

(54) Overcoat composition for printed images

(75) Inventors: Hwei-Ling Yau, Rochester, NY (US); David S. Uerz, Ontario, NY (US); Paul D. Yacobucci, Rochester, NY (US); Catherine A. Falkner, Rochester, NY (US); Wendy S. Krzemien, Hilton, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/984,717

(22) Filed: Nov. 9, 2004

(51) Int. Cl. C03C 17/00; C09D 11/00

(52) U.S. Cl. 523/160; 523/161

(57) ABSTRACT

This invention relates to a substantially colorless ink or overcoat composition comprising an aqueous medium and a polyurethane polymer that has an acid number of 60 to 100 and a weight average molecular weight of greater than 10,000. It particularly relates to an ink jet ink comprising said colorless ink composition.

### FIELD OF THE INVENTION

This invention relates to an aqueous ink or overcoat composition that is substantially colorless. The composition is particularly useful for printed images, particularly ink jet printed images. The invention provides photographic-quality printed images that have superb stain and scratch resistance.

### BACKGROUND OF THE INVENTION

Ink jet printing is a non-impact method for producing printed images by the deposition of ink droplets in a pixel-by-pixel manner to an recording element in response to digital data signals. There are various methods that may be utilized to control the deposition of ink droplets on the recording element to yield the desired printed image. In one process, known as drop-on-demand ink jet, individual ink droplets are projected as needed onto the recording element to form the desired printed image. Common methods of controlling the projection of ink droplets in drop-on-demand printing include piezoelectric transducers and thermal bubble formation. In another process, known as continuous ink jet, a continuous stream of droplets is charged and deflected in an image-wise manner onto the surface of the recording element, while un-imaged droplets are caught and returned to an ink sump. Ink jet printers have found broad applications across markets ranging from desktop document and photographic-quality imaging, to short run printing and industrial labeling.

It is well known in the art that printed images generated using ink jet technology are not very stable with regard to environmental effects of light and ozone. Another problem with such printed images is that they are easily scratched during handling and are not resistant to typical aqueous solutions such as coffee, fruit punch, etc.

Several methods have been used to protect printed images generated using ink jet technology. One method is referred to as lamination and involves the application of a clear durable film over the printed image. Another method involves printing onto specially designed ink jet recording elements which are subsequently fused to form a clear durable film over the printing image. Both of these methods have drawbacks in that an integral or peripheral fusing station is required.

Another method for increasing the durability of printed images involves application of an overcoat composition onto the surface of the printed image using a brush, roller, sponge, etc. As the composition dries, a clear durable film is formed. This method is useful in a variety of commercial printing applications but is considered too impractical and undesirable for consumer use in the home. To this end, the use of a colorless ink supplied in a printhead of an ink jet printer has become increasingly popular. The printhead containing the colorless ink is typically part of the same carriage assembly containing colored inks, and the printer is instructed to jet the colorless ink either simultaneously with or after the colored inks are jetted.

U.S. Pat. No. 6,087,051; U.S. 2003/0193553 A1; U.S. 2003/0005945 A1; JP 2003-291484 A; JP 2000-225695 A; and JP 2002-144551 A describe methods of ink jet printing wherein a colorless ink is used to equalize gloss and/or provide image permanence. These references describe the use of polyurethanes in the colorless inks, but do not describe how the physical properties of the polyurethanes should be optimized in order to obtain jettablity over extended periods of time, and at the same time, provide stain and durability for images printed on a variety of media.

U.S. 2002/0156153 A1 describes the use of polymeric additives in fixatives for ink jet printing in order to improve print quality and image permanence attributes on plain paper. This application discloses that a wide variety of polymers can be used, as long the polymer glass transition temperature (Tg), melting temperature, and molecular weight each fall into a particular range. The fixatives, however, require high amounts of organic solvents for jetting, making the fixatives environmentally unfriendly and unsuitable for use on glossy ink jet recording elements.

U.S. Pat. No. 6,604,819 B2 relates to an ink jet image recording method that includes the application of a solution having fine polymer particles, including polyurethanes as one class, during or after printing colored inks in order to provide weather fastness. This patent states that the particles must have a weight average molecular weight of at least 100,000 such that a film is formed therefrom. However, polyurethanes having a weight average molecular weight of at least 100,000 are difficult to jet, especially from a thermal printhead.

U.S. 2002-0009547 A1 relates to a coating liquid for application to recorded images in order to provide image permanence, fixation and glossiness. This application discloses that fine polymer particles may be used in the coating liquid, and that it is especially desirable if the particles have an acid number of 100 or less. This application does not describe how the physical properties of polymers must be optimized in order to obtain jettability, stain resistance and rub resistance.

There is a continuing need for coating compositions for printed images which are jettable, durable and colorless.

### SUMMARY OF THE INVENTION

The invention provides a substantially colorless ink or overcoat composition comprising an aqueous medium and a polyurethane that has an acid number of 60 to 100 and a molecular weight of greater than 10,000 and preferably less than 50,000. The acid number is preferably provided by carboxylic acid groups that are partially or completely neutralized. The composition forms a film when deposited on a substrate.

The invention also provides an ink set comprising at least one substantially colorless ink composition comprising a polyurethane polymer that has an acid number of 60 to 100 and a molecular weight of greater than 10,000, and preferably less than 50,000, and at least one colored ink comprising a pigment or a dye.

The invention also provides an ink jet printing method comprising the steps of A) providing an ink jet printer that is responsive to digital data signals; B) loading the printer with an ink jet recording element; C) loading the printer with a substantially colorless ink jet ink composition comprising a polyurethane polymer that has an acid number of 60 to 100 and a molecular weight of greater than 10,000; and D) printing on the ink jet recording element using the colorless ink jet composition in response to the digital data signals.

The substantially colorless ink or overcoat composition provides superior stain and scratch resistance when deposited on a substrate. The substantially colorless composition can be applied to a substrate using any conventional coating means, or it can be jetted using an ink jet printer.

### DETAILED DESCRIPTION OF THE INVENTION

The polyurethane used in the invention has an acid number of 60 to 100, and preferably from 65 to 95. When used herein, the term “acid number”, also known as “acid value”, is defined by the number of milligrams of potassium hydroxide required to neutralize one gram of polymer. Thus, the acid number of a given polymer is related to the percent of acid-containing monomer or monomers. The higher the acid number, the more acid functionality is present in the polymer. The inventors have found that if the acid number is too high (greater than 100), then the substantially colorless composition will not provide adequate stain protection, and if the acid number is too low (less than 60), then the jettability of the substantially colorless composition using an ink jet printhead will be compromised, especially when using a thermal drop-on-demand printhead. Preferably the acid number is supplied by carboxylic acid groups and preferably the acid number is supplied by at least one monomer comprising at least two hydroxyl groups.

Preferably the invention employs a polyurethane formed from at least one monomer comprising at least two hydroxyl groups and at least one carboxylic acid group, and another monomer comprising at least two isocyanate groups. The acid number of the polyurethane is provided by acid groups that are, in turn, provided by the at least one monomer comprising at least two hydroxyl groups and at least one carboxylic acid group. The remaining acid groups are also preferably carboxylic acid groups, but any type of acid group may be used. Examples of monomers comprising at least two hydroxyl groups and at least one carboxylic acid group are 2,2-bis(hydroxymethyl) propionic acid and the hydroxyethylether of 4,4-bis(4-hydroxyphenyl)valeric acid. Other examples are described in U.S. Pat. No. 6,268,101 B1 and U.S. 2003/0184629 A1 and references cited therein.

The polyurethanes used in the invention are also derived from a monomer having at least two isocyanate groups; diisocyanates are typically used in the art of polyurethane chemistry, but triisocyanates may also be used. Examples of diisocyanates include isophorone diisocyanate and others described in the above references.

The polyurethanes used in the invention are optionally derived from a second monomer comprising at least two hydroxyl groups and which is different from the first monomer having at least two hydroxyl groups and at least one carboxyl group. These optional monomers are typically higher molecular weight monomers having a molecular weight of less than 3000. They are often referred to in the art as polyols and examples include those described in the above references. Examples include polyols and polyhydroxy derivatives of polycarbonates, polyethers, polyesters, polyacetals, polyacrylates, polyester amides and polythioethers. Preferably, the optional monomer comprising at least two hydroxyl groups is a poly(hexamethylene carbonate) diol. In one embodiment of the substantially colorless composition the first monomer is 2,2-bis(hydroxymethyl) propionic acid and the second monomer is a poly(hexamethylene carbonate) diol The polyurethane used in the invention has a weight average molecular weight, Mw, of greater than 10,000. If Mw is less than 10,000, then the substantially colorless ink or overcoat composition will not provide adequate stain and scratch resistance. The maximum Mw of the polyurethane is not particularly limited, but preferably less than 100,000 and more preferably less than 50,000. If the substantially colorless composition is used as an ink jet ink for a thermal printhead, then preferably the maximum Mw of the polyurethane is 30,000. The maximum molecular weight may be higher for a piezo printhead, although by using a custom designed head and the right formulation, it is possible higher MW materials could be jetted from a piezo head.

Before preparing the substantially colorless composition, an aqueous solution of the polyurethane is typically prepared by neutralization of the carboxylic acid groups using inorganic or organic bases such as alkali metal hydroxides, ammonia, mono-, di- and trialkyl- or aryl amines, etc. Specific examples of bases include sodium hydroxide, potassium hydroxide, and lithium hydroxide. The amount of base used must be enough to partially or completely neutralize the carboxylic acid groups of the polyurethane, and is typically enough to neutralize at least 50% or more of the acid groups.

The polyurethane is present in the substantially colorless composition in an amount required to provide adequate stain and scratch resistance after the composition has been applied and dried. By the term “stain and scratch resistance” is meant herein that, after application, the printed image has improved resistance towards aqueous-based stains such as fruit punch, coffee, etc., and scratches that typically occur during handling. Furthermore, the dry laydown of polyurethane is not particularly limited and is determined not only by the inherent capacity of that polyurethane to provide stain and scratch resistance, but also by numerous other factors, for example, the other components present in the substantially colorless composition. If the substantially colorless composition is an ink jet ink that is jetted using an ink jet printhead, then additional factors include resolution and drop size capacity of the printhead, print speed, masking pattern, etc., as well as the properties of the ink and recording element used to form the printed image. In general, the polyurethane is present in the substantially colorless composition in an amount of up to 20% by weight of the composition. The polyurethane is preferably present in an amount of up to 10% by weight of the composition. Generally the polyurethane is present in an amount of at least 1%.

The substantially colorless composition may be applied to a printed image using any conventional type of application method used for post-treatment of printed images or surface treatment in general. For example, the substantially colorless composition can be sprayed on using a spray can or spray bar, or it can be applied with a sponge, brush or the like. The substantially colorless composition may also be coated on the printed image using rod, knife, air knife, or hopper coating means. The physical properties and formulations of the substantially colorless composition need to be optimized depending on the particular method being used, as will be recognized by the skilled artisan.

In a preferred embodiment, the substantially colorless composition is applied to a printed image using an ink jet printhead. Any type of printhead may be used including, but not limited to, drop-on-demand printheads which utilize piezoelectric transducers or thermal bubble formation, or continuous printheads which utilize electrostatic charging devices and deflector plates, or multiple drop volume with gas deflection technology, such as described in U.S. Pat. No. 6,554,410. The invention is particularly suitable for use with a thermal printhead. Examples of printheads useful in the invention include those used in Canon USA, Inc., Hewlett-Packard Co., and Epson America Inc. desktop and wide-format ink jet printers, and in printing systems described in U.S. 2004/0100542 A1; U.S. 2003/0117465 A1; U.S. 2003/0043223 A1, U.S. Pat. No. 6,079,821; U.S. Pat. No. 6,450,619 B1; U.S. Pat. No. 6,217,163 B1; U.S. 2004/0032473 A1, U.S. 2003/0189626 A1, or U.S. 2004/0017406 A1. The printhead used in the invention may be part of any type of conventional inkjet printing system that deposits one or more inks or fluids onto a recording element.

This invention further comprises an ink jet printing method comprising the steps of:

A) providing an ink jet printer that is responsive to digital data signals;

B) loading said printer with an ink jet recording element;

C) loading said printer with a substantially colorless ink jet ink composition comprising a polyurethane polymer that has an acid number of 60 to 100 and a molecular weight of greater than 10,000 as described above; and

D) printing on said ink jet recording element using said colorless ink jet composition in response to said digital data signals. In a preferred embodiment the printer comprises a thermal printhead.

The printhead containing the substantially colorless composition may be positioned in any one of the printhead ports intended for use with printheads containing colored inks, or it may be positioned in a printhead port that is intended for use with a colorless ink as described in the above references. The printhead containing the substantially colorless composition may be positioned on the same carriage assembly as the one used for colored inks, or it may be on a separate carriage assembly. The actual jetting of the substantially colorless composition may occur before, after, or at the same time as the colored inks, and either in the same pass as the one that jets the colored inks, or in a different pass.

When used as an ink jet ink, the formulation of the substantially colorless composition depends upon the design of the printhead or printing system being used, and will probably be similar to the formulations of the colored inks that are used in that particular printhead or printing system. Substantially colorless ink compositions useful in the invention may include humectants and/or co-solvents in order to prevent the ink composition from drying out or crusting in the nozzles of the printhead, aid solubility of the components in the ink composition, or facilitate penetration of the ink composition into the recording element after printing.

Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, glycerol, 2-methyl-2,4-pentanediol, 1,2,6-hexanetriol, 2-ethyl-2-hydroxymethyl-1,3-propanediol, 1,5 pentanediol, 1,2-hexanediol, and thioglycol; (3) lower mono- and di-alkyl ethers derived from the polyhydric alcohols; (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol. Typical aqueous-based ink compositions useful in the invention may contain, for example, the following components based on the total weight of the ink: water 20-95%, humectant(s) 5-70%, and co-solvent(s) 2-20%.

Other components present in the substantially colorless ink compositions of the invention include surfactants, defoamers, biocides, buffering agents, conductivity enhancing agents, anti-kogation agents, drying agents, waterfast agents, chelating agents, light stabilizers, or ozone stabilizers. The substantially colorless ink or overcoat composition may be colored with very small amounts of colorants in order to impart a desired hue to any or all of the printed image, or in some cases, to correct the color balance of a printed image. Useful colorants include pigments, dyes, polymeric dyes, loaded-dye/latex particles, or combinations thereof, and many of these types of colorants are well known in the art of ink jet inks. In general, colorants may be used in an amount of up to about 0.2% by weight of the composition.

The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink, as is well known in the art of inkjet printing. Acceptable surface tensions are no greater than 60 dynes/cm, and preferably in the range of 20 dynes/cm to 45 dynes/cm.

In one embodiment the substantially colorless ink described above is part of an ink set comprising at least the substantially colorless ink composition and at least one colored ink comprising a pigment or a dye. The colored ink may also comprise the polyurethane polymer described above.

The substantially colorless ink composition of the invention may be applied to a printed image that has been generated by just about any imaging means. Examples of imaging means include ink jet printing, thermal dye transfer printing, silver halide technology, offset printing, etc. It is especially desirable to print the substantially colorless ink composition on a printed image that has been generated by ink jet printing. In this case, virtually any combination of ink jet ink composition and recording element may be used to prepare the printed image. Ink jet ink compositions, well known in the art of ink jet printing, include both dye-based and pigment-based inks, and either may be used to generate the printed image. Representative examples of such inks are disclosed in U.S. Pat. Nos. 5,997,622; 5,985,017; 5,616,174; 5,738,716; 5,536,306; 4,381,946; 4,239,543; and 4,781,758.

The substantially colorless ink composition of the invention can be applied to various recording elements well known in the art of ink jet printing including both porous and swellable types, and either may be used to generate the printed image. Representative examples of such recording elements are disclosed in U.S. Pat. Nos. 6,045,917; 5,605,750; 5,723,211; 5,789,070 and EP 813 978 A1. In a preferred embodiment of the invention, porous recording elements are employed because they dry quickly. In another preferred embodiment of the invention, porous recording elements having high gloss are employed because they render photographic quality printed images.

The following example is provided to illustrate, but not to limit, the invention.

### EXAMPLE

Polymer Characterization

Weight Average Molecular Weight M_{w}

Polymer samples were analyzed by size-exclusion chromatography using differential viscometry detection and a universal calibration curve as described in: T. H. Mourey and T. G. Bryan, Journal of Chromatography A, 964(2002) 169-178. The eluent employed was 1,1,1,3,3,3-hexafluoroisopropanol containing 0.01M tetraethylammonium nitrate. Columns used were two 7.5 mm×300 mm PLGel Mixed-C columns, available from Polymer Labs, and both columns were thermostated at 45° C. The absolute molecular weight distribution was calculated from viscosity data, and a universal calibration curve constructed from narrow-molecular weight poly(methylmethacrylate) standards between 620 (log M=2.79) and 1,450,000 (log M=6.16). Any portion of a polymer distribution appearing beyond the calibration range of the column set was not used for quantitative purposes. The ordinate “Wₙ (log M)” was proportional to the weight fraction of the polymer at a given molecular weight on a logarithmic scale. Weight average molecular weight (M_{w}) and number average molecular weight (Mₙ) in HFIP at 45° C. are reported.

Calculated Acid, Number, AN

Acid number is defined as the amount of KOH (in mg) required to neutralize 1 g of polymer. The acid number for each of the polymers was calculated using the amount of the monomer having a carboxylic acid group, the total amount of the monomers used in the synthesis of the polymer, and the molecular weight of the base used to neutralize the polymer according to the following equation:

$$AN = ( \frac{amount of BHMPA ( mol )}{total amount of monomers ( g )} ) ( MW of base ( \frac{g}{mol} ) ) ( 1000 )$$

For example, referring to Polyurethane 1 of the Invention, PU-1, that is described below, the acid number was calculated as follows: the amount of the monomer having a carboxylic acid group was 0.432 mol, the total amount of the monomers used in the synthesis of the PU-1 was (136+57.9+107.8) g=301.7 g, and the molecular weight of KOH is 56 g/mol:

$$AN = ( \frac{0.432 mol}{301.7 g} ) ( 56 \frac{g}{mol} ) ( 1000 ) = 80$$

Preparation of Polyurethanes
Polyurethane 1 of the Invention, PU-1

In a 1-liter round bottom flask equipped with thermometer, stirrer, water condenser and a vacuum outlet was placed 136 g (0.068 moles) of poly(hexamethylene carbonate) diol (PHMC), avg. Mₙ=2000 (Aldrich 46,116-4). It was dewatered under vacuum at 100° C. The vacuum was released and the following were added at 40° C. while stirring: 57.9 g (0.432 moles) 2,2-bis(hydroxymethyl) propionic acid 0 DMPA, 160 g tetrahydrofuran (THF), and 1 mL of stannous octoate (catalyst). The temperature was adjusted to 68° C., and when a homogeneous solution was obtained, 107.8 g (0.485 moles) of isophorone diisocyanate (IPDI) was slowly added, followed by 10 mL THF. The temperature was raised to 72° C. and maintained for about 16 hours to complete the reaction, resulting in an intermediate containing less than 3% of free IPDI. The free IPDI content was monitored by IR spectroscopy of the absorption peak at 2240 wave number.

The reaction mixture was diluted with 200 mL THF, and neutralized with 53.86 g of 45 wt. % KOH solution to achieve 100% stoichiometric ionization based on the amount of DMPA. Under high shear, 900 mL of distilled water was added and THF was subsequently removed by heating under vacuum to give an aqueous solution of PU-1 at 27.51 wt. % solids. The molecular weights of PU-1 were M_{w}=18,800 and Mₙ=8440; and the AN=80.

Polyurethane 2 of the Invention, PU-2

The procedure was repeated with the following monomers: 132 g (0.066 moles) of PHMC diol; 3 g (0.022 moles) of trimethylolpropane (TMP); 56.9 g (0.424 moles) DMPA; and 106.7 g (0.480 moles) IPDI. Neutralization required 52.87 g of 45 wt. % KOH solution. The final solution was 26.62 wt. % solids. The molecular weights of PU-2 were M_{w}=18,400 and Mₙ=7630; and the AN=80.

Polyurethane 3 of the Invention, PU-3

The procedure was repeated with the following monomers: 126 g (0.063 moles) of PHMC diol; 6 g (0.044 moles) of TMP; 55.9 g (0.416 moles) DMPA; and 106.7 g (0.480 moles) IPDI. Neutralization required 52 g of 45 wt. % KOH solution. The final solution was 25.92 wt. % solids. The molecular weights of PU-3 were M_{w}=20,100 and Mₙ=7910; and the AN=80.

Polyurethane 4 of the Invention, PU-4

The procedure was repeated with the following monomers: 169 g (0.084 moles) of PHMC diol (same material but purchased from Stahl as KM101122); 56.3 g (0.420 moles) DMPA; and 80.1 g (0.360 moles) IPDI. Neutralization required 52.4 g of 45 wt. % KOH solution. The final solution was 33.56 wt. % solids. The molecular weights of PU-4 were M_{w}=13,000 and Mₙ=8040; and the AN=79.

Polyurethane 5 of the Invention PU-5

The procedure was repeated with the following monomers: 140 g (0.070 moles) of PHMC diol; 57.7 g (0.430 moles) DMPA; and 106.7 g (0.480 moles) IPDI. Neutralization required 53.62 g of 45 wt. % KOH solution. The final solution was 32.34 wt. % solids. The molecular weights of PU-5 were M_{w}=12,800 and Mₙ=5620; and the AN=79.

Polyurethane 6 of the Invention, PU-6

The procedure was repeated with the following monomers: 210 g (0.105 moles) of PHMC diol; 53.0 g (0.395 moles) DMPA; and 106.7 g (0.480 moles) IPDI. Neutralization required 49.25 g of 45 wt. % KOH solution. The final solution was 32.92 wt. % solids. The molecular weights of PU-6 were M_{w}=18,500 and Mₙ=8830; and the AN=60.

Comparative Polyurethane A, Comparative PU-A

The procedure was repeated with the following monomers: 28.0 g (0.014 moles) of PHMC diol; 65.2 g (0.486 moles) DMPA; and 102.2 g (0.460 moles) IPDI. Neutralization required 60.0 g of 45 wt. % KOH solution. The final solution was 33.16 wt. % solids. The molecular weights of Comparative PU-A were M_{w}=6500 and Mₙ=3050; and the AN=139.

Comparative Polyurethane B, Comparative PU-B

The procedure was repeated with the following monomers: 54.0 g (0.027 moles) of PHMC diol (same material but purchased from Stahl as KM11122); 63.4 g (0.473 moles) DMPA; and 102.2 g (0.460 moles) IPDI. Neutralization required 59 g of 45 wt. % KOH solution. The final solution was 27.95 wt. % solids. The molecular weights of Comparative PU-B were M_{w}=7320 and Mₙ=2790; and the AN=121.

Comparative Polyurethane C, Comparative PU-C

The procedure was repeated with the following monomers: 46.4 g (0.054 moles) of PHMC diol, avg. Mₙ=860 (Stahl KM101733); 59.8 g (0.446 moles) DMPA; and 102.2 g (0.460 moles) IPDI. Neutralization required 53.9 g of 29 wt. % NH₄OH solution. The final solution was 24.52 wt. % solids. The molecular weights of Comparative PU-C were M_{w}=6710 and Mₙ=3140; and the AN=120.

Comparative Polyurethane D, Comparative PU-D

The procedure was repeated with the following monomers: 90.0 g (0.045 moles) of PHMC diol; 61.0 g (0.455 moles) DMPA; and 102.2 g (0.460 moles) IPDI. Neutralization required 56.7 g of 45 wt. % KOH solution. The final solution was 30.38 wt. % solids. The molecular weights of Comparative PU-D were M_{w}=9080 and Mₙ=4000; and the AN=101.

Compositions and properties of the polyurethanes described above are summarized in Table 1.

TABLE 1

| | Weight % | | | | | |
|---|---|---|---|---|---|---|
| | PHMC | | | | | |
| Polyurethane | Diol | TMP | DMPA | IPDI | M_{w} | AN |
| PU-1 | 45.1 | 0 | 19.2 | 35.7 | 18,800 | 80 |
| PU-2 | 44.7 | 1 | 19.2 | 36.1 | 18,400 | 80 |
| PU-3 | 43.7 | 2 | 19.4 | 37.0 | 20,100 | 80 |
| PU-4 | 55.3 | 0 | 18.4 | 26.2 | 13,000 | 79 |
| PU-5 | 46.0 | 0 | 18.9 | 35.1 | 12,800 | 79 |
| PU-6 | 56.8 | 0 | 14.3 | 28.9 | 18,500 | 60 |
| Comparative | 14.3 | 0 | 33.4 | 52.3 | 6500 | 139 |
| PU-A | | | | | | |
| Comparative | 24.6 | 0 | 28.9 | 46.5 | 7320 | 121 |
| PU-B | | | | | | |
| Comparative | 22.3 | 0 | 28.7 | 49.0 | 6710 | 120 |
| PU-C | | | | | | |
| Comparative | 35.5 | 0 | 24.1 | 40.4 | 9080 | 101 |
| PU-D | | | | | | |

Preparation of Ink Compositions
Ink Composition 1 of the Invention, Ink I-1

Ink I-1 was prepared using polyurethane PU-1 described above to give 3 wt. % of polyurethane relative to the total weight of the ink. Other additives included diethylene glycol at 10 wt. %, ethyleneglycol monobutylether (Dowanol® DB from Dow Chemical Co.) at 2.5 wt. %, Silwet® L-77 (Osi Specialties, Inc.) at 0.5 wt. %, and the balance water.

Additional inventive and comparative ink compositions were prepared as described for Ink I-1, except that different polyurethanes and amounts were used. A summary of the ink compositions is described in Table 2.

TABLE 2

| | | Amount of Polyurethane |
|---|---|---|
| Ink | Polyurethane | (wt. %) |
| I-1 | PU-1 | 3 |
| I-2 | PU-2 | 3 |
| I-3 | PU-3 | 3 |
| I-4 | PU-4 | 4 |
| I-5 | PU-5 | 3 |
| I-6 | PU-6 | 3 |
| Comparative Ink I-A | Comparative PU-A | 3 |
| Comparative Ink I-B | Comparative PU-B | 3 |
| Comparative Ink I-C | Comparative PU-C | 3 |
| Comparative Ink I-D | Comparative PU-D | 3 |

Printing and Evaluation

A Canon i960 Photo Printer from Canon U.S.A., Inc. was used to print the ink compositions described above. For each ink composition, a test patch about 25 cm² was printed at 100% ink coverage and allowed to dry at ambient conditions overnight. Each patch was then stained by placing 0.2 mL of Hawaiian Punch® fruit juice on the surface that filled a dot having a diameter of about 1 cm. After one minute, the fruit juice was wiped up with a Sturdi-Wipes paper towel that had a 500 g weight on top of it. Each ink composition was printed on the following ink jet recording elements:
Epson Premium Glossy Photo Paper (# S041286) from Epson America, Inc.;
Canon Photo Paper Pro (no catalogue #) from Canon U.S.A., Inc.; and
Ilford Galerie Professional Inkjet Photo Range Smooth Gloss Paper (#197 9312 IGSGP9US) from Ilford Imaging U.S.A., Inc.

Each of the samples were evaluated for stain and wipe resistance. Stain density was measured using an X-Rite® Model 820; values less than 0.10 are acceptable. Wipe resistance was measured by qualitatively evaluating the surface of the wipe recording element for scratches:

A—no surface scratches

B—very mild scratches

C—severe scratches

D—very severe scratches on the surface and pink/red stain were observed.

The results are shown in Table 3.

TABLE 3

| Ink | Stain Density | | | Wipe Resistance | |
|---|---|---|---|---|---|
| Composition | Epson | Canon | Ilford | Epson | Canon |
| I-1 | 0.08 | 0.07 | 0.07 | A | A |
| I-2 | 0.08 | 0.07 | 0.07 | A | A |
| I-3 | 0.09 | 0.07 | 0.08 | A | A |
| I-4 | 0.08 | 0.07 | 0.08 | A | A |
| I-5 | 0.08 | 0.07 | not | A | A |
| | | | tested | | |
| I-6 | 0.09 | 0.07 | not | A | A |
| | | | tested | | |
| Comparative | 0.21 | 0.25 | 0.10 | D | D |
| Ink I-A | | | | | |
| Comparative | 0.20 | 0.20 | 0.07 | D | D |
| Ink I-B | | | | | |
| Comparative | 0.22 | 0.23 | 0.12 | D | D |
| Ink I-C | | | | | |
| Comparative | 0.18 | 0.10 | 0.08 | D | D |
| Ink I-D | | | | | |
| Control | 0.22 | 0.18 | 0.31 | not | not |
| (No colorless | | | | tested | tested |
| ink applied) | | | | | |

The results in Table 3 show that the Inks of the Invention provide better stain and wipe resistance as compared to the Comparative Inks. The desired properties are obtained because acid number and molecular weight of the polyurethane polymers have been co-optimized.

The invention has been described in detail with particular reference to certain preferred embodiments thereof, but it will be understood that variations and modifications can be effected within the spirit and scope of the invention.

1. A substantially colorless ink or overcoat composition comprising an aqueous medium and a polyurethane polymer that has an acid number of 60 to 100 and a weight average molecular weight of greater than 10,000.

2. The substantially colorless composition of claim 1 wherein the polyurethane polymer has a weight average molecular weight of 10,000 to 50,000.

3. The substantially colorless composition of claim 1 wherein the polyurethane polymer has a weight average molecular weight of 10,000 to 30,000.

4. The substantially colorless composition of claim 1 wherein the polyurethane polymer has an acid number of 65 to 95.

5. The substantially colorless composition of claim 1 wherein the acid number is provided by carboxylic acid groups.

6. The substantially colorless composition of claim 1 wherein the polyurethane is derived from at least one monomer comprising at least two hydroxyl groups and at least one carboxylic acid group and another monomer comprising at least two isocyanate groups.

7. The substantially colorless composition of claim 6 wherein the polyurethane is derived from at least a first monomer comprising at least two hydroxyl groups and at least one carboxylic acid group, a second monomer comprising at least two hydroxyl groups, and a monomer comprising at least two isocyanate groups.

8. The substantially colorless composition of claim 7 wherein the first monomer is 2,2-bis(hydroxymethyl) propionic acid.

9. The substantially colorless composition of claim 7 wherein the second monomer is a polyether.

10. The substantially colorless composition of claim 7 wherein the second monomer is a polyester.

11. The substantially colorless composition of claim 7 wherein the second monomer has a molecular weight of less than 3000.

12. The substantially colorless composition of claim 7 wherein the second monomer is a polycarbonate.

13. The substantially colorless composition of claim 7 wherein the second monomer is a poly(hexamethylene carbonate) diol.

14. The substantially colorless composition of claim 1, wherein the acid groups are partially or completely neutralized.

15. The substantially colorless composition of claim 1, wherein 50% or more of the acid groups are neutralized.

16. The substantially colorless composition of claim 14, wherein the acid groups are neutralized with potassium hydroxide, sodium hydroxide, or lithium hydroxide.

17. The substantially colorless composition of claim 6 wherein the monomer comprising at least two isocyanate groups is isophorone diisocyanate.

18. The substantially colorless composition of claim 1, wherein the polyurethane polymer is present in an amount of up to 20% by weight of the composition.

19. The substantially colorless composition of claim 1 wherein the polyurethane polymer is present in an amount of up to 10% by weight of the composition.

20. The substantially colorless composition of claim 1 wherein the composition forms a film when deposited on a substrate.

21. The substantially colorless composition of claim 1 wherein the composition is an ink jet ink.

22. The substantially colorless composition of claim 21 wherein the polyurethane polymer has a molecular weight of 10,000 to 30,000 and an acid number of 65 to 95 wherein the acid number is provided by carboxylic acid groups; the polyurethane is derived from at least a first monomer comprising at least two hydroxyl groups and at least one carboxylic acid group, a second monomer comprising at least two hydroxyl groups, and a monomer comprising at least two isocyanate groups; and the acid groups are partially or completely neutralized.

23. The substantially colorless composition of claim 22 wherein the first monomer is 2,2-bis(hydroxymethyl) propionic acid and the second monomer is a poly(hexamethylene carbonate) diol

24. The substantially colorless composition of claim 22, wherein 50% or more of the acid groups are neutralized.

25. An ink set comprising at least one substantially colorless ink composition comprising a polyurethane polymer that has an acid number of 60 to 100 and a molecular weight of greater than 10,000 and at least one colored ink comprising a pigment or a dye.

26. The ink set of claim 25 wherein the polyurethane polymer has a molecular weight of 10,000 to 50,000.

27. The ink set of claim 25 wherein the colored ink further comprises a polyurethane polymer that has an acid number of 60 to 100 and a molecular weight of greater than 10,000.

28. The ink set of claim 27 wherein the colored ink further comprises a polyurethane polymer that has an acid number of 60 to 100 and a molecular weight of 10,000 to 50,000.

29. The ink set of claim 25 wherein 50% or more of the acid groups are neutralized.

30. The ink set of claim 27 wherein 50% or more of the acid groups are neutralized.

31. An ink jet printing method comprising the steps of:
A) providing an ink jet printer that is responsive to digital data signals;
B) loading said printer with an ink jet recording element;
C) loading said printer with a substantially colorless ink jet ink composition comprising a polyurethane polymer that has an acid number of 60 to 100 and a molecular weight of greater than 10,000; and
D) printing on said ink jet recording element using said colorless ink jet composition in response to said digital data signals.

32. The ink jet printing method of claim 31 wherein the printer comprises a thermal printhead.

33. The ink jet printing method of claim 32 wherein the polyurethane polymer has a molecular weight of 10,000 to 50,000.

34. The substantially colorless composition of claim 7, wherein the monomer comprising at least two isocyanate groups is isophorone diisocyanate.
